(19) United States
(12) Patent Application Publication
(10) Pub. No.: US 2025/0252090 A1
(43) Pub. Date: Aug. 7, 2025

(54) METHOD FOR ESTABLISHING OBJECT INDEX, TRAINING PREDICTION MODEL AND SEARCH

(71) Applicant: Hangzhou Alibaba International Internet Industry Co., Ltd., Hangzhou (CN)

(72) Inventors: Yanjing WU, Hangzhou (CN); Yinfu FENG, Hangzhou (CN); Rong XIAO, Hangzhou (CN); Haihong TANG, Hangzhou (CN)

(21) Appl. No.: 19/023,236

(22) Filed: Jan. 15, 2025

(30) Foreign Application Priority Data
Feb. 2, 2024 (CN) 202410153896.0

(51) Int. Cl. G06F 16/22; G06F 16/28; G06N 20/00

(52) U.S. Cl. CPC G06F 16/2219; G06F 16/2246; G06F 16/285; G06N 20/00

(57) ABSTRACT

The present application provides a method for establishing an object index, a method for training a prediction model, and a search method. The method for establishing an object index includes: obtaining multimodal features of each object under a target leaf category; performing multi-level clustering on the objects under the target leaf category based on the multimodal features to generate an object clustering hierarchy diagram; and establishing an object index value for each of the objects based on the object clustering hierarchy diagram. The object index value obtained through this method integrate richer object information, providing stronger indexing capabilities for objects and significantly improving indexing efficiency.

### CROSS-REFERENCE TO RELATED APPLICATIONS

This application claims priority to Chinese Patent Application No. 202410153896.0, filed with the China National Intellectual Property Administration on Feb. 2, 2024, and entitled “Method for Establishing Object Index, Training Prediction Model and Search,” which is incorporated herein by reference in its entirety.

### TECHNICAL FIELD

The present application relates to the field of computer technology, and in particular, to a method for establishing an object index, a method for training an object index prediction model, a search method, an e-commerce platform, an electronic device, a storage medium, and a computer program product.

### BACKGROUND

In e-commerce scenarios, the search results presented to users are obtained by sorting the retrieved results of products based on preset strategies. Product retrieval results refer to the products retrieved from the product database that match a given query text. In the prior art, commonly used product retrieval algorithms can be roughly categorized into three types: keyword-based inverted index retrieval, such as traditional keyword retrieval and query-to-product ID retrieval; relationship-based inverted index retrieval, such as Item-to-Item (object-to-object, abbreviated as I2I) and User-to-Item (user-to-object); vector-based index retrieval, such as personalized vector retrieval and cross-lingual vector retrieval. These three types of retrieval algorithms rely on the characteristics of underlying index structures, static ranking methods, and query methods to retrieve a target product set from massive amounts of data that meets application requirements. Typically, the process involves first searching for candidate products and then using a retrieval algorithm to further filter the candidate products to obtain the target products. Although the aforementioned retrieval algorithms in the prior art can retrieve suitable products, they require traversing the candidate product space. When the candidate product space is large, the retrieval efficiency is significantly reduced, leading to low efficiency in search applications based on the retrieved results.

It is evident that the search methods in the prior art still require improvement.

### SUMMARY

The embodiments of the present application provide a method for establishing an object index and a search method based on the object index established using this method. These methods can improve the indexing efficiency of object on e-commerce platforms and enhance the accuracy of object searches.

Accordingly, the embodiments of the present application further provide a method for training an object index prediction model, an e-commerce platform, an electronic device, a storage medium, and a computer program product to ensure the implementation and application of the aforementioned methods.

The method for establishing an object index disclosed in the embodiments of the present application includes the following steps:
obtaining multimodal features of each object under a target leaf category;
performing multi-level clustering on the objects under the target leaf category based on the multimodal features to generate an object clustering hierarchy diagram;
establishing an object index value for each of the objects based on the object clustering hierarchy diagram.

The search method disclosed in the embodiments of the present application includes the following steps: in response to an object query request, obtaining text information corresponding to the object query request;
based on the text information, obtaining an object index value, wherein the object index value includes multi-level index values from top to bottom;
using an object-to-object association algorithm to determine a first candidate object to be retrieved that is similar to the object corresponding to the object index value;
based on the object index value and a pre-generated object clustering hierarchy diagram corresponding to the object index value, determining a second candidate object to be retrieved;
aggregating the first candidate object and the second candidate object to obtain the object search results.

The embodiments of the present application also disclose a method for training an object index prediction model, which includes the following steps:
using descriptive text of an object as input data and pre-obtained object index value of the object as output data to construct a first fine-tuning sample;
fine-tuning an initial object index prediction model based on the first fine-tuning sample to obtain a fine-tuned object index prediction model;
periodically obtaining a second fine-tuning sample in real time and iteratively fine-tuning the fine-tuned object index prediction model based on the second fine-tuning sample to update the object index prediction model, wherein the second fine-tuning sample is constructed as follows: using historical query text within a specified time period and corresponding click category sequences of the historical query text as input data, and using the object index value of the object clicked in response to the historical query text as output data.

The embodiments of the present application also disclose a search method, which includes the following steps:
obtaining a query text entered by a user based on an object query operation;
generating an object query request based on the query text;
sending the object query request to a preset server;
displaying an object search result sent by the preset server in response to the object query request, wherein the object search result is obtained by the preset server through the following steps: in response to the object query request, obtaining text information corresponding to the object query request; based on the text information, obtaining an object index value, wherein the object index value includes multi-level index value from top to bottom; using an object-to-object association algorithm to determine a first candidate object to be retrieved that are similar to the object corresponding to the object index value; based on the object index value and a pre-generated object clustering hierarchy diagram corresponding to the object index value, determining a second candidate object to be retrieved; aggregating the first candidate objects and the second candidate object to obtain the object search result.

The embodiments of the present application also disclose an e-commerce platform, which includes a client and a server, wherein:
a client is configured to send an object query request to a server based on an object query operation performed by a user;
a server is configured to respond to the object query request by obtaining the text information corresponding to the object query request and, based on the text information, obtaining object index value, wherein the object index value include multi-level index value arranged from top to bottom;
the server is further configured to use an object-to-object association algorithm to determine a first candidate object to be retrieved that are similar to the object corresponding to the object index value, and to determine a second candidate object to be retrieved based on the object index value and a pre-generated object clustering hierarchy diagram corresponding to the object index value;
the server is further configured to aggregate the first candidate object and the second candidate object to generate an object search result;
the server is further configured to send the object search result to the client;
the client is further configured to display the object search result.

The embodiments of the present application also disclose an electronic device, which includes: a processor; and a memory communicatively connected to the processor; the memory stores a computer-executable instruction, and the processor executes the computer-executable instructions stored in the memory to implement the methods described in the embodiments of the present application.

The embodiments of the present application also disclose a computer-readable storage medium, which stores computer-executable instructions. When executed by a processor, the computer-executable instructions implement the methods described in the embodiments of the present application.

The embodiments of the present application also disclose a computer program product, which includes a computer program or computer-executable instructions. When executed by a processor in an electronic device, the computer program or computer-executable instructions implement the methods described in the embodiments of the present application.

Compared with the prior art, the embodiments of the present application include the following advantages:
by obtaining the multimodal features of objects under a target leaf category; performing multi-level clustering on the objects under the target leaf category based on the multimodal features to generate an object clustering hierarchy diagram; and establishing object index values for each of the objects based on the object clustering hierarchy diagram, the resulting object index values integrate richer object information and provide stronger indexing capabilities, thereby effectively improving object indexing efficiency. Furthermore, by using the object indexing method disclosed in the embodiments of the present application to index objects on an e-commerce platform, the accuracy of object retrieval can be enhanced, which in turn improves the accuracy and efficiency of search applications based on the retrieved objects.

### BRIEF DESCRIPTION OF THE DRAWINGS

FIG. 1 is a step flowchart of one embodiment of the method for establishing an object index disclosed in the present application;

FIG. 2 is a schematic diagram of the object clustering hierarchy generated during the execution of the method for establishing an object index disclosed in the present application;

FIG. 3 is another step flowchart of one embodiment of the method for establishing an object index disclosed in the present application;

FIG. 4 is a step flowchart of one embodiment of the search method disclosed in the present application;

FIG. 5 is a schematic flow diagram of the method for training an object index prediction model disclosed in the present application;

FIG. 6 is a schematic diagram of the structure of the object index prediction model disclosed in the present application;

FIG. 7 is a schematic diagram of the structure of an exemplary device provided in one embodiment of the present application.

### DETAIL DESCRIPTION OF THE EMBODIMENTS

To make the objectives, features, and advantages of the present application more apparent and understandable, the following provides a further detailed description of the present application in conjunction with the accompanying drawings and specific embodiments.

The object indexing method and search method disclosed in the embodiments of the present application can be applied to e-commerce platforms.

Differentiable Search Index (DSI) is a new search paradigm that learns a Query-to-DocID text retrieval model, directly mapping user queries to relevant document identifier nodes. In the prior art, DSI is primarily used for searching massive amounts of documents in search engines, with the implementation steps as follows: firstly, for all documents, a BERT model is used to generate textual vectors for the documents. These textual vectors are then subjected to hierarchical clustering, and the results of multiple rounds of hierarchical clustering are concatenated to form the differentiable search index for each document. Subsequently, a training process is conducted using query or document text as input and the corresponding differentiable search index of the document as output to train an index generation model. During the search phase, the current query is used as input to invoke the index generation model, generating a differentiable search index. The document identifier corresponding to the generated differentiable search index is then used as the final retrieved result.

Since search objects have different characteristics, the differentiable search index in the prior art cannot meet the object retrieval requirements of e-commerce platforms for the following reasons: the vectors used to generate the differentiable search index are textual vectors produced by the BERT model based on document text. However, in e-commerce platforms, the query content primarily consists of product titles, which typically have limited textual information, low relevance between texts, and diverse descriptions for the same product. In such scenarios, generating a differentiable search index based on product titles using the aforementioned method results in reduced indexing efficiency for the products.

To address the issues of low product retrieval efficiency and low search efficiency in e-commerce platforms in the prior art, the embodiments of the present application provide a method for establishing an object index and a search method. These methods enable end-to-end direct retrieval of products in search scenarios without the need to search through a candidate product space. Compared with the search methods in the prior art, the search method disclosed in the embodiments of the present application can directly retrieve products that match both the user and the query based on the user's input. This approach not only accelerates the query process but also improves the relevance and diversity of the retrieved products, thereby enhancing the accuracy of the search results.

The following provides an exemplary description of a specific embodiment of the object indexing method disclosed in the present application.

Referring to FIG. 1, in an optional embodiment, the object indexing method disclosed in the present application includes S102 to 106.

S102: obtaining multimodal features of each object under a target leaf category.

In the context of e-commerce search scenarios, the “object” in the embodiments of this application may refer to a product on an e-commerce platform. The “leaf category” of an object refers to the terminal node in the product category classification system, representing the most detailed category with no further subdivisions. For example, if the category of an object is: Electronics→Mobile Phones→Smartphones, “Smartphones” would be the leaf category. Generally, the leaf category of an object effectively identifies its specific type. In the embodiments of this application, a multi-level object index value is generated for each object, with the top-level index value of the multi-level object index value being derived from the object's leaf category. For instance, the identifier of the object's leaf category can be encoded and displayed as the top-level index value of the hierarchical object index value for the corresponding object.

Specifically, in the embodiments of this application, the object index value generated for each object can be represented in the form of “I1 I2 I3 . . . In,” which includes n hierarchical index values, where n is an integer greater than 3. I1 represents the top-level index value, I2 represents the second-level index value, and in represents the nth-level index value. The hierarchical levels from I1 to In decrease progressively.

The top-level index value I1 is determined based on the object's leaf category. For example, if the identifier of the leaf category to which an object belongs is “100000075,” the top-level index value in the object's index value can be set to “100000075.”

The index values for other hierarchical levels are determined based on the hierarchical clustering results of objects under the corresponding leaf category. The value of n is equal to the number of clustering iterations plus 1. The number of clustering iterations is determined based on the number of objects under the leaf category and the maximum number of objects allowed in each cluster at each hierarchical level. For example, if an e-commerce platform has at most 5 million objects under a single leaf category, and the number of objects in each cluster at the bottom level of the hierarchical clustering process is less than or equal to 50, the number of required clusters can be calculated using the formula 504−6,250,000. Since 6,250,000>5,000,000, the number of clustering iterations can be set to 4. In this case, n is set to 5, meaning the object index value includes 5 hierarchical index levels.

In the embodiments of the present application, multi-level clustering is performed separately for the objects under each leaf category to obtain the multi-level clustering results of the objects in that leaf category. The multi-level clustering results are represented using an object clustering hierarchy diagram. During the multi-level clustering process, clustering is based on the multimodal features of the objects. Therefore, it is necessary to first obtain the multimodal features of each object.

In some optional embodiments, the multimodal features of an object are obtained using the following method: obtaining vectors of one or more of the following object features: text feature vectors, image feature vectors, and efficiency feature vectors; concatenating the obtained feature vectors to generate the multimodal features of the corresponding object.

The text features are used to characterize the descriptive text of the object, such as the title content and/or object details. For example, the text feature vector may be a textual vector obtained by encoding product description texts, such as the product title and/or product detail text. In some optional embodiments, the product title and product detail description set by merchants when listing products on an e-commerce platform can be obtained. The retrieved text is then input into a pre-trained BERT model, and the encoded vector generated by the BERT model for this text is used as the text feature vector for the product. An 8-layer BERT model from the prior art can be used as the BERT model. The specific method for generating the text feature vector for an object is not limited in the embodiments of this application.

The image feature vector can be obtained by encoding object images, such as the main image or detail images, to generate image vectors. In some optional embodiments, a pre-trained BLIP (Bootstrapping Language-Image Pre-training) model can be used to extract vectors from the specified images of the object to obtain the image feature vector of the object. The BLIP model is a pre-training model that unifies visual and language understanding and generation, with the ability to describe image content. For example, the BLIP model can be fine-tuned using <object image, object title>data pairs to obtain a fine-tuned BLIP model. During the fine-tuning process, the input is the object image, the output is the object title, and the image dimensions for the image encoder are specified. In the image feature extraction stage, the object image is input into the fine-tuned BLIP model, which outputs a vector of the specified dimension as the image feature vector of the input image.

The efficiency features refer to the characteristics of object performance metrics predefined by the e-commerce platform, such as efficiency-related indicators. These efficiency indicators include, but are not limited to, one or more of the following metrics: click-through rate, conversion rate, and purchase volume within a specified time period on the e-commerce platform. Subsequently, these efficiency indicators are encoded to generate a vector of a specified dimension, which serves as the efficiency feature vector of the object.

In some optional embodiments, the text feature vector, image feature vector, and efficiency feature vector for each object can be obtained using the methods described above. These vectors are then concatenated in a preset order to form a concatenated vector, which is used as the multimodal feature vector of the corresponding object. The dimensionality of the text feature vector, image feature vector, and efficiency feature vector can be determined based on actual needs and the parameter settings of the models used. For example, the dimensionality can be set to 128 dimensions.

S104: performing multi-level clustering on the objects under the target leaf category based on the multimodal features to generate an object clustering hierarchy diagram.

As described earlier, after determining the number of hierarchical clustering iterations, performing the specified number of hierarchical clustering iterations for the objects under each leaf category based on their respective multimodal features.

In some optional embodiments, performing multi-level clustering on the objects under the target leaf category based on their multimodal features to generate an object clustering hierarchy diagram includes: performing multi-level clustering on the objects under the target leaf category based on their multimodal features according to an upper limit threshold for the number of objects within each cluster, to obtain clustering results for each level; generating an object clustering hierarchy diagram based on the clustering results for each level, wherein the clustering results for each level include: information about the clustering categories obtained in the current level and information about the objects within each clustering category.

The upper limit threshold for the number of objects within each cluster is manually set as required. For example, if the upper limit threshold is set to 50 and the number of clustering iterations is set to 4, performing hierarchical clustering for a specific leaf category (e.g., smartphones) on an e-commerce platform involves the following: restricting the maximum number of objects within each cluster (i.e., clustering category) to 50 and invoking K-means hierarchical clustering 4 times based on the multimodal features of all objects under the leaf category. This process yields the hierarchical clustering results for the objects under the leaf category. The hierarchical clustering results include the clustering category information obtained from each iteration of the hierarchical clustering. The clustering category information includes: the number of clustering categories generated in the current iteration; the identifier of each clustering category; the object identifiers of the objects within each clustering category.

The process of performing multi-level clustering on the objects under a target leaf category is a step-by-step classification process, where the classification granularity is progressively refined. The target leaf category can be understood as the largest-granularity category encompassing all objects under that category. After the first iteration of hierarchical clustering, the clustering results represent the first-level refined classification of all objects under the target leaf category. Similarly, the second iteration of hierarchical clustering further refines the classification results obtained from the first level, producing second-level refined classification results. By executing hierarchical clustering iteratively in this manner, the objects under the target leaf category are classified step by step with increasing granularity. During each iteration, the same object is assigned to one clustering category at that level. Consequently, after N iterations of clustering, each object under the target leaf category will be assigned to at most N hierarchical categories with parent-child relationships.

In some embodiments, if the number of objects within the target leaf category is too small, such as only 100 objects, a single clustering iteration may suffice to achieve clustering results where the maximum number of objects in each cluster (i.e., clustering category) does not exceed 50, based on the constraint of a maximum of 50 objects per cluster. In this case, further hierarchical clustering iterations are unnecessary. Specifically, during the hierarchical clustering process, if the number of objects within a cluster is already less than or equal to the upper limit threshold for objects per cluster, the hierarchical clustering process is terminated early. Under such circumstances, each object under the target leaf category will be assigned to two hierarchical categories with a parent-child relationship.

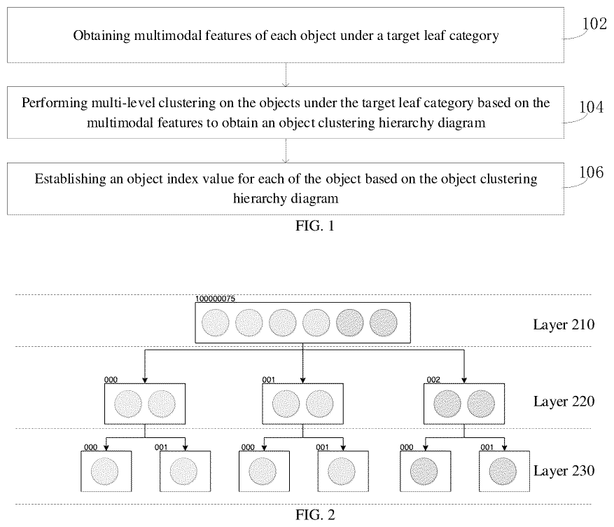

Furthermore, the clustering results obtained from each iteration of hierarchical clustering on the objects under the target leaf category can be represented using a hierarchical structure to obtain an object clustering hierarchy diagram corresponding to the target leaf category. Referencing the object clustering hierarchy diagram shown in FIG. 2, the following provides an illustrative example of the method for generating the object clustering hierarchy diagram.

For example, the target leaf category can be set as the top-level category in the object clustering hierarchy diagram. The clustering categories obtained from the first iteration of hierarchical clustering are represented as subcategories of the target leaf category, which form the next level of clustering categories under the top-level category. These can be referred to as “second-level clustering categories.” As shown in FIG. 2, the objects in layer 210 represent the objects under the target leaf category. After the first iteration of hierarchical clustering, the objects under the target leaf category are divided into different clustering categories, such as the clustering categories labeled 000, 001, and 002 in layer 220. During the second iteration of hierarchical clustering, the objects within each clustering category from layer 220 (e.g., 000, 001, and 002) are further clustered into different clustering categories in layer 230. For instance, the objects within clustering category 000 in layer 220 are further divided into clustering categories labeled 000 and 001 in layer 230. After completing the specified number of hierarchical clustering iterations, each object is assigned to a single clustering category in each iteration.

S106: establishing an object index value for each of the objects based on the object clustering hierarchy diagram.

From the generation process of the object clustering hierarchy diagram described above, it can be seen that the object clustering hierarchy diagram is used to describe the hierarchical clustering categories to which the objects belong during the multi-level clustering process.

Furthermore, establishing the object index values for each of the objects based on the object clustering hierarchy diagram includes: determining the top-level index value of the object based on the target leaf category; determining the index values for each hierarchical level corresponding to the clustering categories to which the object belongs in each level; concatenating the top-level index value and the index values for each hierarchical level in descending order of the hierarchical clustering categories, from higher to lower levels, to generate the object index value for each of the object.

In some optional embodiments, the category identifier of the target leaf category can be used as the top-level index value, i.e., the first-level index value, for all objects under the target leaf category. The identifier of the clustering category to which an object belongs during the first iteration of hierarchical clustering can be used as the second-level index value (i.e., the next top-level index value). Similarly, the identifier of the clustering category to which an object belongs during the second iteration of hierarchical clustering can be used as the third-level index value. This process continues, assigning hierarchical index values based on the clustering category identifiers corresponding to each iteration of hierarchical clustering. The multi-level index values for an object are then generated by sequentially concatenating the second-level index value, third- level index value, and so on, after the first-level index value, up to the index value corresponding to the last hierarchical clustering iteration. For example, for an object A with a category identifier of “100000075,” if it belongs to the clustering categories identified as 000, 001, 001, and 002 in the first through fourth hierarchical clustering iterations respectively, its object index value can be represented as: “100000075 000 001 001 002”.

In some optional embodiments, if the number of clustering hierarchy levels for a particular object is less than the preset number of hierarchy levels, the corresponding index depth will be less than the preset depth value. In this case, specified values can be appended to the concatenated object index value to ensure consistent index length, facilitating subsequent retrieval operations.

Using the above method, the object index values for the existing objects on the e- commerce platform can be obtained. Furthermore, by associating each object's index value with its object identifier, objects can be indexed based on their index values to retrieve the corresponding object identifiers, thereby enabling retrieval operations for the objects.

In summary, the object indexing method disclosed in the embodiments of this application includes obtaining the multimodal features of objects under the target leaf category; performing multi-level clustering on the objects under the target leaf category based on the multimodal features to generate an object clustering hierarchy diagram; and establishing an object index value for each of the objects based on the object clustering hierarchy diagram. The resulting object index values incorporate richer object information, providing stronger indexing capabilities for the objects and effectively improving indexing efficiency.

Furthermore, using the identifier of the leaf category to which an object belongs as the prefix of the object index value significantly enhances the identification capability of the object index value for the object, thereby further improving the indexing efficiency.

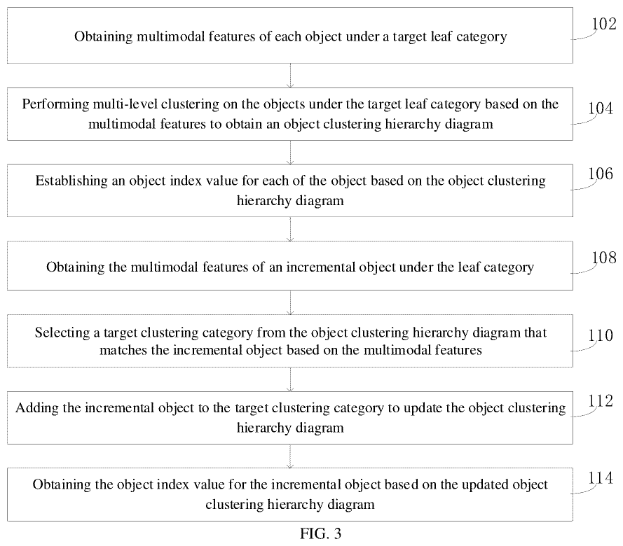

In practical applications, the products (i.e., objects) on an e-commerce platform are dynamic, with new products continuously being added. If the aforementioned method is used to re-perform hierarchical clustering and re-establish object index values for all products based on the clustering results, it would not only consume excessive computational resources but also significantly reduce the efficiency of building object index values. To address the issue of establishing object index values for newly added products, as shown in FIG. 3, some optional embodiments include the following steps after establishing object index values based on the object clustering hierarchy diagram: S108, S110, S112, and S114.

S108: obtaining the multimodal features of an incremental object under the leaf category.

The specific implementation for obtaining the multimodal features of incremental objects under the leaf category can refer to the previously described embodiments for obtaining the multimodal features of existing objects on the e-commerce platform. This will not be elaborated here.

S110: selecting a target clustering category from the object clustering hierarchy diagram that matches the incremental object based on the multimodal features.

As previously described, the object clustering hierarchy diagram outlines the clustering categories obtained during each iteration of the hierarchical clustering process and the objects within each clustering category. In some optional embodiments, the clustering category that best matches a given incremental object can be determined by evaluating the matching degree between existing clustering categories and the incremental object. The specified incremental object is then added to the most compatible clustering category, enabling rapid classification of the incremental object.

In some optional embodiments, selecting the target clustering category that matches the incremental object from the clustering categories in the object clustering hierarchy diagram based on the multimodal features includes the following steps: obtaining the category feature vectors of each bottom-level clustering category in the object clustering hierarchy diagram; selecting candidate clustering categories from the bottom-level clustering categories based on the similarity distance between the multimodal features of the incremental object and the category feature vectors; determining the candidate clustering category as the target clustering category that matches the incremental object, or selecting the target clustering category from sibling clustering categories, based on the number of existing objects in the candidate clustering category and/or the number of existing objects in the sibling clustering categories of the candidate clustering category. The sibling clustering categories refer to the clustering categories under the same parent category as the candidate clustering category.

In the embodiments of this application, it is preferable to select the clustering category from the bottom-level clustering categories obtained through multi-level clustering with the highest similarity between its category center feature and the features of the incremental object as the candidate clustering category for the incremental object. The category center feature of a clustering category is calculated during the hierarchical clustering process. If the number of existing objects in the candidate clustering category is greater than or equal to the upper limit threshold for objects per category minus one, an existing subcategory under the parent category of the candidate clustering category is selected as the new candidate clustering category for the incremental object.

As a specific example, assuming four iterations of hierarchical clustering, the process begins by obtaining the category center feature vectors of the clustering categories generated in the fourth iteration of hierarchical clustering (i.e., the bottom-level clustering categories in the fifth layer of the object clustering hierarchy diagram). Next, the similarity distances between the multimodal features of the incremental object and the category center feature vectors of each clustering category are calculated. The clustering category with the smallest similarity distance is selected, and the incremental object is added to this category. If adding the incremental object causes the number of objects in the current clustering category to exceed the upper limit threshold for objects per category (e.g., 50), all clustering categories under the parent category of the current clustering category (i.e., the fifth-layer clustering categories in the object clustering hierarchy diagram) are checked. A clustering category in the fifth layer that has not reached the upper limit threshold for objects is selected, and the incremental object is added to this category.

By prioritizing the selection of the bottom-level clustering category with the highest similarity to the multimodal features of the incremental object as its clustering category, the classification accuracy of the incremental object can be improved.

S112: adding the incremental object to the target clustering category to update the object clustering hierarchy diagram.

Subsequently, the incremental object is added to the target clustering category. As a result, the objects within the target clustering category in the object clustering hierarchy diagram are updated, thereby updating the object clustering hierarchy diagram.

S114: obtaining the object index value for the incremental object based on the updated object clustering hierarchy diagram.

Using the method described in the previous embodiments for obtaining object index values based on the object clustering hierarchy diagram, the object index value for the incremental object is obtained from the updated object clustering hierarchy diagram.

At this point, the object index value for the incremental object has been successfully obtained.

In summary, the object indexing method disclosed in the embodiments of this application involves obtaining the multimodal features of incremental objects under a leaf category and selecting the target clustering category that matches the incremental objects from the clustering categories in the object clustering hierarchy diagram based on these multimodal features. Subsequently, the incremental objects are added to the target clustering category, updating the object clustering hierarchy diagram. Based on the updated object clustering hierarchy diagram, the object index values of the incremental objects are obtained. This method eliminates the need to re-perform multi-level clustering for all objects, enabling the rapid construction of multi-level object index values for newly added objects. It is more efficient and conserves computational resources.

Referring to FIG. 4, based on the aforementioned embodiments, the present application discloses a search method, which includes S402 to 410.

S402: in response to an object query request, obtaining text information corresponding to the object query request.

During the operation of an e-commerce platform, the object indexing method described in the previous embodiments is first used to establish object index values for both existing and incremental objects on the platform. This facilitates the rapid retrieval of objects using their object index values. When a user enters a query text into the client of the e-commerce platform and performs an object query operation (e.g., a product search), the client generates an object query request based on the user's input query text and sends this request to the server of the e-commerce platform. Upon receiving the object query request, the server further retrieves the text information corresponding to the request.

In some optional embodiments, obtaining the text information corresponding to the object query request includes the following steps: retrieving the query text corresponding to the object query request; retrieving the click category sequence corresponding to the query text; obtaining the text information corresponding to the object query request based on the query text and the click category sequence. The object query request contains the query text corresponding to the current query. The query text may be user-entered keywords, such as “red dress.”

The server first parses the object query request to retrieve the query text contained within the request. Subsequently, the server retrieves historical query records from the e-commerce platform based on the query text and obtains the click category sequence corresponding to the most recent occurrence of the query text within a specified time period. For example, the server may obtain the click category sequence associated with the last time a user entered the query text and interacted with the retrieval results within the past seven days. Using the parsed query text and the retrieved click category sequence, the server then generates the text information corresponding to the object query request. For instance, the parsed query text and the retrieved click category sequence can be concatenated to form a concatenated text, which is used as the text information corresponding to the object query request.

The click category sequence corresponding to the query text can represent the sequence of leaf categories of the retrieved objects that the user clicked on in order when interacting with the retrieved objects for the given query text. In some optional embodiments, the server retrieves the text information corresponding to the object query request, which can be represented, for example, as: “The query is red dress. Query category is 0002621, 20127376”, where “0002621, 20127376” indicates the click category sequence.

S404: obtaining an object index value based on the text information.

The object index value includes multi-level index values arranged from top to bottom.

In some optional embodiments, obtaining the object index value based on the text information includes: inputting the text information into a pre-trained object index prediction model and retrieving the object index value output by the prediction model.

For example, during the object retrieval stage, a generative approach can be used to execute object retrieval. First, the text information obtained from the current object query request is used as the input to a pre-trained object index prediction model. The object index prediction model is then invoked, triggering it to generate object index values based on the text information.

The object index prediction model is designed to generate object index values that match the input text.

In some optional embodiments, the object index prediction model is trained using the following method: using the descriptive text of an object as input data and the pre-obtained object index value of the object as output data to construct the first fine-tuning sample; fine-tuning an initial object index prediction model based on the first fine-tuning sample to obtain a fine-tuned object index prediction model; real-time acquisition of second fine-tuning samples at preset intervals and iteratively fine-tuning the fine-tuned object index prediction model based on the second fine-tuning samples to update the object index prediction model. The second fine-tuning samples are constructed using the following method: using historical query text within a specified time period and the corresponding click category sequences of the historical query text as input data, and using the object index values of the clicked objects corresponding to the historical query text as output data.

The specific training method for the object index prediction model is detailed in the relevant descriptions of the embodiments below and will not be elaborated here.

Alternatively, the object index value is generated by sequentially concatenating the index value corresponding to the object's leaf category with the index values corresponding to the hierarchical clustering categories obtained through multi-level clustering of the objects under the leaf category. The format and composition of the object index value are described in detail in the relevant sections of the previous embodiments.

Alternatively, the object index prediction model is built based on a BART model and uses the beam search method to sequentially generate the index value for each hierarchical level. During the process of generating object index values for each input text information, the beam search algorithm retains the top M (where M is an integer greater than 1) output sequences with the highest conditional probabilities at each step while generating each word. As a result, for each input text information, the object index prediction model can output multiple object index values.

Due to prediction latency constraints, the number of object index values directly generated using the generative retrieval method for a single object query request is limited, typically not exceeding 50. However, in search and recommendation scenarios with billions of candidates, 50 objects are insufficient. Additionally, due to limitations in object content, efficiency, and other factors, it is challenging for these objects to be effectively ranked and presented to users through subsequent sorting processes. To make full use of the generated object index values, the embodiments of this application further retrieve additional relevant candidate objects as retrieval objects. This is achieved based on the second-level index values (next-to-top-level index values) of the object index values generated by the object index prediction model and the I2I (Item-to-Item) retrieval results corresponding to the object index values.

In some optional embodiments, obtaining the object index value based on the text information includes the following steps: matching the text information with historical text information corresponding to past object query requests and retrieving the matching result; if the matching result indicates a successful match with the historical text information, retrieving the pre-stored object index value predicted based on the historical text information and using it as the object index value for the objects to be retrieved; if the matching result indicates that no target text information corresponding to a historical object query request was found, inputting the text information into a pre-trained object index prediction model and retrieving the object index value output by the prediction model.

The historical object query requests refer to query requests within a specified time period before the current time. The historical text information corresponding to these historical query requests consists of the text information associated with the query requests during that specified time period. For example, after obtaining the text information corresponding to a query request and retrieving the object index value based on the text information, the text information of that query request is stored as historical text information and is associated with the retrieved object index value. This creates a mapping between historical text information and object index values. When subsequent query requests are received, the corresponding current text information for the query request is first checked against the pre-stored mapping. If the current text information matches any historical text information in the mapping, the associated object index value is retrieved and directly used as the object index value for the current text information. If no matching historical text information is found in the mapping, the current text information is processed through the object index prediction model to predict its corresponding object index value.

S406: using an object-to-object association algorithm to determine a first set of candidate objects to be retrieved that are similar to the object corresponding to the object index value.

The object-to-object association algorithm, also referred to as the “Item2Item” retrieval algorithm (abbreviated as “I2I retrieval”), is a retrieval algorithm commonly used in recommendation systems. It is designed to identify items similar to those previously favored by the user and recommend them to the user. The I2I retrieval algorithm determines the similarity between items by analyzing user-item interaction data, such as user preferences, purchases, and ratings.

In some embodiments of the present application, after retrieving objects on the e-commerce platform based on the generated object index values, multiple objects can be obtained as base objects. Furthermore, the I2I retrieval algorithm can be used to retrieve similar objects for each base object. These similar objects are then designated as the first set of candidate objects to be retrieved.

S408: determining a second set of candidate objects to be retrieved based on the object index value and a pre-generated object clustering hierarchy diagram corresponding to the object index value.

The object clustering hierarchy diagram is generated using the following method: obtaining the multimodal features of objects under the target leaf category; performing multi-level clustering on the objects under the target leaf category based on the multimodal features to generate the object clustering hierarchy diagram corresponding to the target leaf category.

The specific method for generating the object clustering hierarchy diagram is detailed in the relevant descriptions of the previous embodiments and will not be elaborated here.

As described earlier, the object index value is obtained by performing multi-level clustering on objects under the same leaf category based on their multimodal features and deriving the index values from the clustering results. Therefore, the object index value can be used to identify other objects that are similar to a given object.

In some optional embodiments, determining the second set of candidate objects to be retrieved based on the object index values and the pre-generated object clustering hierarchy diagram corresponding to the object index values includes the following steps: parsing the object index value to obtain the top-level index value and the second-level index value; using the pre-generated object clustering hierarchy diagram corresponding to the top-level index value to determine the second set of candidate objects corresponding to the second-level index value. For example, for a given object index value, its structure can be used to extract the first part of the index value (i.e., the index value corresponding to the leaf category) as the top-level index value of a pre-generated object clustering hierarchy diagram. The second part of the index value (i.e., the index value corresponding to the clustering category obtained from the first iteration of hierarchical clustering) can be extracted as the second-level index value of the object clustering hierarchy diagram. Taking the object index value “100000075 000 001 001 002” as an example, parsing the value yields a top-level index value of “100000075” and a second-level index value of “000”. Next, the pre-generated object clustering hierarchy diagram corresponding to the top-level index value “100000075” (i.e., the diagram associated with the leaf category identifier “100000075”) is located. Then, within the object clustering hierarchy diagram for the leaf category identifier “100000075”, objects from the clustering category identified as “000” in the second-level clustering category are retrieved. The second set of candidate objects is selected from these objects.

The object clustering hierarchy diagram is used to describe the hierarchical clustering categories to which each object belongs during the multi-level clustering process of objects under the target leaf category. Here, the target leaf category corresponds to the top-level index value. Determining the second set of candidate objects to be retrieved based on the pre-generated object clustering hierarchy diagram corresponding to the top-level index value and the second-level index value includes the following steps: using the pre-generated object clustering hierarchy diagram corresponding to the top-level index value to retrieve the objects corresponding to the second-level index value as candidate retrieval objects; selecting a preset number of candidate retrieval objects as the second set of candidate objects, in descending order of their preset metric values. The preset metric values may include efficiency metrics.

Furthermore, to improve the quality of the retrieved objects, the retrieved objects need to be filtered first. Taking the object index value “100000075 000 001 001 002” as an example, after locating the pre-generated object clustering hierarchy diagram corresponding to the top-level index value “100000075”, all objects within the clustering category identified as “000” in the second-level clustering category of the hierarchy diagram can be treated as candidate retrieval objects. Subsequently, the candidate retrieval objects are sorted based on efficiency metrics. The top-ranked objects, according to the efficiency metric (e.g., the top 10,000 objects), are selected as the second set of candidate objects to be retrieved.

S410: aggregating the first set of candidate objects to be retrieved and the second set of candidate objects to be retrieved to obtain an object search result.

After obtaining the first set of candidate objects and the second set of candidate objects using different methods, further aggregation processing can be performed on these two sets of objects to generate the final object search results.

Alternatively, aggregating the first set of candidate objects and the second set of candidate objects to obtain the object search results includes: merging the first set of candidate objects and the second set of candidate objects, and performing deduplication to generate the final object search results.

In the embodiments of this application, the execution order of S406 and S408 can be interchanged.

In summary, the search method disclosed in the embodiments of this application involves the following: based on an object query request, using a pre-trained object index prediction model to obtain object index values, where the object index values include multi-level index values arranged from top to bottom. Using an object-to-object association algorithm to determine the first set of candidate objects that are similar to the object corresponding to the object index value. Based on the object index values and the pre-generated object clustering hierarchy diagram corresponding to the object index values, determining the second set of candidate objects. Finally, aggregating the first and second sets of candidate objects to obtain the object search results. This method eliminates the need to first determine a massive set of candidate objects based on matching scores and then retrieve objects from the candidate set. It significantly improves the efficiency of object retrieval. Furthermore, by generating object index values and combining the I2I results of the object index values with similar and popular objects from the next-level categories under the leaf category, the method greatly enhances the coverage and accuracy of the retrieved objects. Tests have shown that using the search method disclosed in this application for object retrieval allows e-commerce platforms to achieve a click-through rate (CTR) exceeding 68% and a transaction rate exceeding 73%. This represents a significant improvement over object retrieval solutions in the prior art. The CTR and transaction rate effectively reflect the relevance of the retrieved objects to the user's query needs. Therefore, the search method disclosed in this application significantly improves the accuracy of object retrieval and the overall search results.

Furthermore, in the search methods of the prior art, object queries typically use only the query text as input information to obtain a single-dimensional condition for retrieval, which limits the accuracy of object retrieval. The search method disclosed in the embodiments of this application combines the query text with the click category sequence from the most recent historical query corresponding to the query text as the query input. This enriches the query conditions, thereby improving the prediction accuracy of the object index prediction model and subsequently enhancing the accuracy of object retrieval.

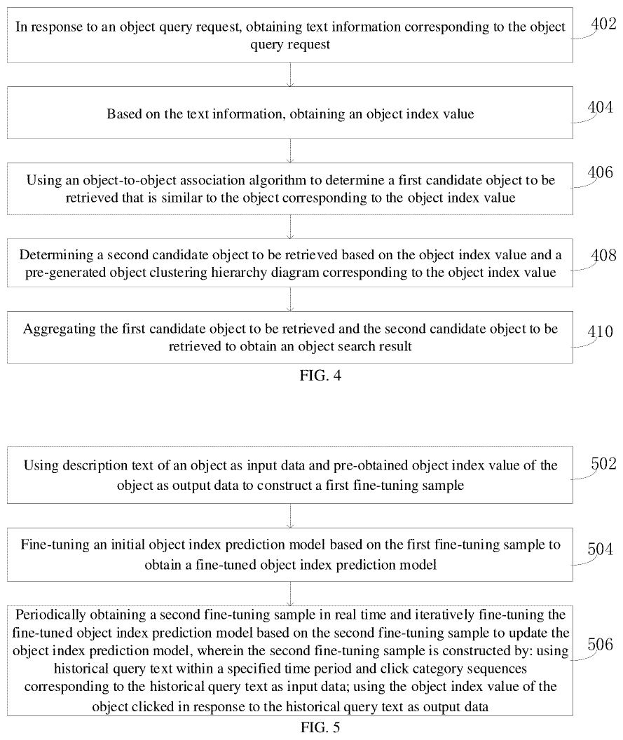

To implement the aforementioned search method, based on the object indexing method disclosed in the preceding embodiments, this application further discloses a method for training an object index prediction model. As shown in FIG. 5, the method includes S502 to 506.

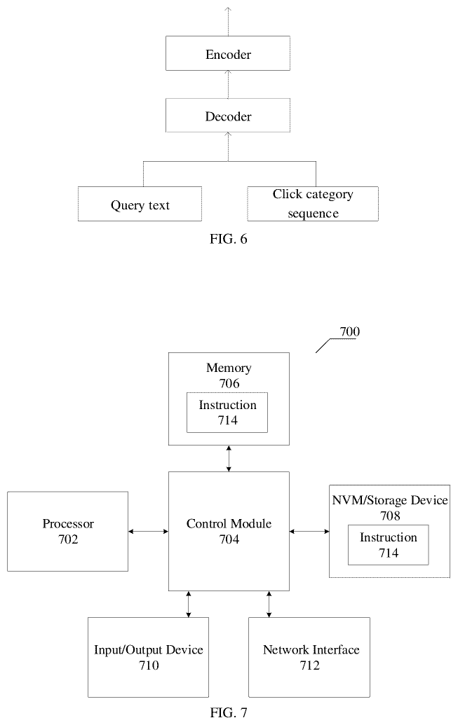

In e-commerce search scenarios, understanding the query text entered by users is fundamental to executing object retrieval. User queries are typically brief and concise, lacking strong sequential relationships. For instance, a user may input “red dress” or “dress red” to express the same query intent. In this application, the object index prediction model adopts a generative model with an “encoder-decoder” structure, as shown in FIG. 6, similar to the structure of a BART model. The BART model is fine-tuned using data from e-commerce search scenarios to obtain an object index prediction model optimized for online application.

In the embodiments of this application, the fine-tuning of the object index prediction model is divided into two stages: first stage: fine-tuning is performed based on the inherent attribute data of objects; second stage: fine-tuning is conducted periodically using real-time user query behavior data. For example, fine-tuning can be based on all click behavior data collected over the past M days as of the current day. The following provides a detailed explanation of the training scheme for the object index prediction model.

S502: using descriptive text of an object as input data and the pre-obtained object index value of the object as output data to construct a first fine-tuning sample.

The descriptive text may include the object title, object details, or similar information.

In some optional embodiments, the object index value is pre-established using the following method: obtaining the multimodal features of objects under the target leaf category; performing multi-level clustering on the objects under the target leaf category based on the multimodal features to generate an object clustering hierarchy diagram; establishing the object index values based on the object clustering hierarchy diagram.

The method for establishing the object index value is detailed in the relevant descriptions of the previous embodiments and will not be elaborated here.

During the first-stage fine-tuning process, data pairs are constructed using descriptive text, such as object titles and/or object details, along with the corresponding object index values. Each data pair generates one first fine-tuning sample. The first fine-tuning sample includes the descriptive text of the object and its corresponding object index value.

S504: fine-tuning an initial object index prediction model based on the first fine-tuning sample to obtain a fine-tuned object index prediction model.

Next, fine-tuning is performed on the initial object index prediction model using the constructed first fine-tuning samples. During the fine-tuning process, for each first fine-tuning sample: the descriptive text of the object (e.g., the object title) from the sample is used as the input data to the model. The object index value from the sample is used as the output data. The model is trained to learn the encoding and mapping relationship between the input data and the output data, to obtain a fine-tuned object index prediction model.

S506: periodically obtaining a second fine-tuning sample in real time and iteratively fine-tuning the fine-tuned object index prediction model based on the second fine-tuning sample to update the object index prediction model. The second fine-tuning sample is constructed using the following method: using historical query text within a specified time period and the corresponding click category sequence of the historical query text as input data; using the object index value of the clicked object corresponding to the historical query text as output data.

The preset period can be one day or another duration. The specified time period can be the seven days prior to the current date or another time period preceding the current date.

Taking a preset period of one day and a specified time period of the past seven days as an example, during the operation of an e-commerce platform, historical query text from the past seven days can be retrieved at a fixed time each day. Along with this, the sequence of leaf categories (click category sequence) corresponding to the objects clicked by users for each historical query text, as well as the object index values of the objects ultimately clicked by users, are collected. Subsequently, for each query text: the query text and its corresponding sequence of leaf categories (click category sequence) are used to construct an input data sample. The object index value of the object ultimately clicked by the user for that query text is used as the output data. This process generates a second fine-tuning sample corresponding to the query text. Using this method, multiple second fine-tuning samples can be constructed based on recent user query data from the e-commerce platform.

Subsequently, the second fine-tuning samples are used to perform the second-stage fine-tuning of the object index prediction model. During the second-stage fine-tuning process: the query text and the click category sequence from each second fine-tuning sample are used as input data. The object index value is used as output data. The current object index prediction model is fine-tuned to update its ability to learn the mapping relationship between the query text, the click category sequence, and the object index value. When the second-stage fine-tuning is executed for the first time, the current object index prediction model is the one obtained after the first-stage fine-tuning. For the second and subsequent executions of the second-stage fine-tuning, the current object index prediction model is the model obtained from the previous round of fine-tuning.

For the object index prediction model obtained after the second-stage fine-tuning, when a query text and a click category sequence are input, the model outputs the corresponding object index value.

In some optional embodiments, before fine-tuning the object index prediction model, the method further includes: adding each hierarchical index value from the pre-established object index values as a basic input unit to the vocabulary of the object index prediction model.

Taking the object index prediction model built on the BART model as an example, before fine-tuning the BART model to obtain the object index prediction model, the hierarchical index values of the object index values for each object on the e-commerce platform can first be retrieved. These hierarchical index values are then configured as special token IDs and added to the model's vocabulary. For instance, the category identifier of the leaf category (e.g., “100000075” as mentioned earlier) and the identifiers of the clustering categories obtained during the multi-level clustering process (e.g., “000”, “001”, “002”, etc.)—which collectively form the components of the object index value—are set as special token IDs. This enables the object index prediction model to encode each index value in the hierarchical object index independently.

Since the hierarchical index values that make up the object index value are mutually independent, configuring the values of these hierarchical index values as token IDs allows the model to encode each hierarchical index value independently. This approach prevents the index values from being segmented by BPE (Byte Pair Encoding), which could otherwise result in the loss of semantic information. It ensures that the object index values are independently tokenized according to the leaf category and category identifiers, thereby helping to improve the prediction accuracy of the model.

The specific implementation of adding token IDs to the vocabulary of the object index prediction model can refer to the prior art and will not be elaborated here.

In summary, the object index prediction model training method disclosed in the embodiments of this application involves the following steps: using the descriptive text of the object as input data and the pre-obtained object index value of the object as output data to construct the first fine-tuning samples; fine-tuning the initial object index prediction model based on the first fine-tuning samples to obtain the fine-tuned object index prediction model; periodically retrieving user query behavior data within a specified time period in real-time, constructing second fine-tuning samples, and iteratively fine-tuning the object index prediction model using the second fine-tuning samples. This approach enhances the prediction accuracy of the fine-tuned object index prediction model for object indexing, thereby improving the retrieval accuracy and search result accuracy of the search method that applies this model.

Based on the above embodiments, this application further discloses an e-commerce platform designed to implement the aforementioned search method.

The e-commerce platform includes: a client, and a server,

The client is configured to send an object query request to the server based on an object query operation performed by the user.

The server is configured to: respond to the object query request by retrieving the text information corresponding to the request; obtaining object index values based on the text information, where the object index values include multi-level index values arranged from top to bottom.

The server is further configured to: using an object-to-object association algorithm to determine the first set of candidate objects to be retrieved that are similar to the object corresponding to the object index value; determining the second set of candidate objects to be retrieved based on the object index value and the pre-generated object clustering hierarchy diagram corresponding to the object index value.

The server is further configured to aggregate the first set of candidate objects and the second set of candidate objects to generate the object search results.

The server is further configured to send the object search results to the client.

The client is further configured to display the object search results.

Alternatively, obtaining the object index value based on the text information includes:
inputting the text information into a pre-trained object index prediction model and retrieving the object index value output by the model.

Alternatively, obtaining the object index value based on the text information includes:
matching the text information with historical text information corresponding to past object query requests to obtain a matching result.

If the matching result indicates a successful match with the historical text information, retrieving the pre-stored object index value predicted based on the historical text information and using it as the object index value for the objects to be retrieved.

If the matching result indicates no match with the target text information corresponding to a historical object query request, inputting the text information into a pre-trained object index prediction model and retrieving the object index value output by the model.

The specific implementation of the operations performed by the server is detailed in the relevant descriptions of the previous embodiments and will not be elaborated here.

In summary, the e-commerce platform disclosed in this application includes a server that, based on object query requests sent by the client, uses a pre-trained object index prediction model to obtain object index values. These object index values include multi-level index values arranged from top to bottom. Subsequently, the server: uses an object-to-object association algorithm to determine the first set of candidate objects that are similar to the object corresponding to the object index value; determines the second set of candidate objects based on the object index value and the pre-generated object clustering hierarchy diagram corresponding to the object index value; finally, the server aggregates the first and second sets of candidate objects to generate object search results. This method eliminates the need to first determine a massive set of candidate objects based on matching scores and then search for retrieval objects from this candidate set, significantly improving object retrieval efficiency and, consequently, object search efficiency. Additionally, by generating object index values and combining the 121 results of the object index values with similar and popular objects from the next-level categories under the leaf category as retrieval results, the method significantly enhances the coverage and accuracy of retrieved objects.

Based on the above embodiments, this application also discloses a search method applicable to a client. The method includes: obtaining the query text entered by the user based on an object query operation; generating an object query request based on the query text; sending the object query request to a preset server; displaying the object search results sent by the preset server in response to the object query request. The object search results are obtained by the preset server through the following steps: responding to the object query request by obtaining the text information corresponding to the request; obtaining object index values based on the text information, where the object index values include multi-level index values arranged from top to bottom; using an object-to-object association algorithm to determine the first set of candidate objects that are similar to the object corresponding to the object index value; determining the second set of candidate objects based on the object index values and a pre-generated object clustering hierarchy diagram corresponding to the object index values; aggregating the first and second sets of candidate objects to generate the object search results.

The specific implementation for obtaining the query text entered by the user based on the object query operation can be found in the relevant descriptions of the previous embodiments and will not be elaborated here.

The specific implementation for the preset server to obtain object search results is detailed in the relevant descriptions of the previous embodiments and will not be elaborated here.

In summary, the search method provided in this application involves sending a query request to a preset server, triggering the server to: responding to the object query request by retrieving the text information corresponding to the request; obtaining the object index values corresponding to the objects to be retrieved based on the text information, where the object index values include multi-level index values arranged from top to bottom; using an object-to-object association algorithm to determine the first set of candidate objects similar to the object corresponding to the object index value; determining the second set of candidate objects based on the object index values and a pre-generated object clustering hierarchy diagram corresponding to the object index values; aggregating the first and second sets of candidate objects to generate the object search results. This method improves the coverage and accuracy of the search results.

It should be noted that, for the sake of simplicity, the method embodiments are described as a series of combined actions. However, those skilled in the art should understand that the embodiments of this application are not limited by the order of the actions described. According to the embodiments of this application, certain steps may be performed in a different order or simultaneously. Furthermore, those skilled in the art should also understand that the embodiments described in the specification are all preferred embodiments, and the actions involved are not necessarily essential for implementing the embodiments of this application.

Based on the aforementioned embodiments, this embodiment further provides an object indexing apparatus, which includes:
an object feature acquisition module, configured to obtain the multimodal features of objects under the target leaf category;
a hierarchical clustering module, configured to perform multi-level clustering on the objects under the target leaf category based on the multimodal features to generate an object clustering hierarchy diagram;
an object index value establishment module, configured to establish the object index values for each of the objects based on the object clustering hierarchy diagram.

Alternatively, after establishing the object index values based on the object clustering hierarchy diagram, the apparatus further includes:
an object feature acquisition module, further configured to obtain the multimodal features of incremental objects under the leaf category;
a target clustering category selection module, configured to select the target clustering category that matches the incremental objects from the clustering categories in the object clustering hierarchy diagram based on the multimodal features;
an object clustering hierarchy diagram update module, configured to add the incremental objects to the target clustering category to update the object clustering hierarchy diagram;
an object index value establishment module, further configured to obtain the object index values for the incremental objects based on the updated object clustering hierarchy diagram.

Alternatively, the target clustering category selection module is further configured to:
obtaining the category feature vectors of each bottom-level clustering category in the object clustering hierarchy diagram;
selecting candidate clustering categories from the bottom-level clustering categories based on the similarity distance between the multimodal features of the incremental object and the category feature vectors;
determining the candidate clustering category as the target clustering category that matches the incremental object, or select the target clustering category from sibling clustering categories based on the number of existing objects in the candidate clustering category and/or the number of existing objects in the sibling clustering categories. The sibling clustering categories are clustering categories under the same parent category as the candidate clustering category.

Alternatively, the multimodal features of the object can be obtained using the following method:
obtaining one or more feature vectors of the object, including: text feature vectors, image feature vectors, and efficiency feature vectors;
concatenating the retrieved feature vectors to generate the multimodal features of the corresponding object.

Alternatively, the object clustering hierarchy diagram is used to describe the hierarchical clustering categories to which the object belongs during the multi-level clustering process. Establishing the object index value based on the object clustering hierarchy diagram includes the following steps:
determining the top-level index value of the object based on the target leaf category;
determining the index values for each hierarchical level corresponding to the hierarchical clustering categories to which the object belongs;
concatenating the top-level index value and the hierarchical index values in descending order of the hierarchical clustering categories to generate the object index value.

In summary, the object indexing apparatus disclosed in the embodiments of this application achieves the following: obtaining the multimodal features of objects under the target leaf category; performing multi-level clustering on the objects under the target leaf category based on the multimodal features to generate an object clustering hierarchy diagram; establishing object index values based on the object clustering hierarchy diagram. The resulting object index values incorporate richer object information, providing stronger indexing capabilities and effectively improving the efficiency of object indexing.

Based on the aforementioned embodiments, this application further provides a search apparatus, which includes:
a text information acquisition module, configured to respond to an object query request by obtaining the text information corresponding to the request;
an object index value prediction module, configured to obtain object index values based on the text information, where the object index values include multi-level index values arranged from top to bottom;
a first retrieval object determination module, configured to use an object-to-object association algorithm to determine the first set of retrieval objects that are similar to the object corresponding to the object index value.
a second retrieval object determination module, configured to determine the second set of retrieval objects based on the object index value and the pre-generated object clustering hierarchy diagram corresponding to the object index value;
a retrieval object aggregation module, configured to aggregate the first and second sets of retrieval objects to generate the object search results.

Alternatively, the object index value prediction module is further configured to:
inputting the text information into a pre-trained object index prediction model to obtain the object index value output by the model.

Alternatively, the object index value prediction module is further configured to:
matching the text information with historical text information corresponding to past object query requests to obtain a matching result;
if the matching result indicates a successful match with the historical text information, retrieve the pre-stored object index value predicted based on the historical text information and use it as the object index value corresponding to the retrieval objects;
if the matching result indicates no match with the target text information corresponding to a historical object query request, input the text information into a pre-trained object index prediction model to obtain the object index value output by the model.

Alternatively, the second retrieval object determination module is further configured to:
parsing the object index value to obtain the top-level index value and the second-level index value;
using the pre-generated object clustering hierarchy diagram corresponding to the top-level index value to determine the second retrieval objects corresponding to the second-level index value.

Alternatively, the object clustering hierarchy diagram is used to describe the hierarchical clustering categories to which each object belongs during the multi-level clustering process of objects under the target leaf category. The target leaf category corresponds to the top-level index value. Determining the second retrieval objects based on the pre-generated object clustering hierarchy diagram corresponding to the top-level index value includes the following steps:
retrieving the objects corresponding to the second-level index value from the pre- generated object clustering hierarchy diagram associated with the top-level index value and treat these objects as candidate retrieval objects;
ranking the candidate retrieval objects in descending order of their preset metric values, and select a preset number of candidate retrieval objects as the second retrieval objects.

Alternatively, the text information acquisition module is further configured to:
obtaining the query text corresponding to the object query request;
obtaining the click category sequence corresponding to the query text;
obtaining the text information corresponding to the object query request based on the query text and the click category sequence.

In summary, the search apparatus disclosed in this application retrieves object index values based on object query requests, where the object index values include multi-level index values arranged from top to bottom. Subsequently, the apparatus: uses an object-to-object association algorithm to determine the first set of retrieval objects similar to the object corresponding to the object index value; determines the second set of retrieval objects based on the object index value and the pre-generated object clustering hierarchy diagram corresponding to the object index value; aggregates the first and second sets of retrieval objects to generate the object search results. This method eliminates the need to first determine a massive set of candidate objects based on matching scores and then retrieve objects from this candidate set, significantly improving retrieval efficiency. By generating object index values and combining the I2I results of the object index values with similar and popular objects from the next-level categories under the leaf category, the method greatly enhances the coverage and accuracy of the retrieval objects, thereby improving the coverage and accuracy of the search results.

Based on the aforementioned embodiments, this application further provides a search apparatus applied to the client. The apparatus includes:
a query text acquisition module, configured to obtain the query text entered by the user based on an object query operation;
an object query request generation module, configured to generate an object query request based on the query text;
an object query request transmission module, configured to send the object query request to a preset server.

A search result display module, configured to display the object search results sent by the preset server in response to the object query request. The object search results are obtained by the preset server through the following steps: responding to the object query request by obtaining the text information corresponding to the request; obtaining object index values based on the text information, where the object index values include multi-level index values arranged from top to bottom; using an object-to-object association algorithm to determine the first set of retrieval objects similar to the object corresponding to the object index value; determining the second set of retrieval objects based on the object index value and the pre-generated object clustering hierarchy diagram corresponding to the object index value; aggregating the first and second sets of retrieval objects to generate the object search results.

The specific implementation for obtaining the query text entered by the user based on the object query operation can be found in the relevant descriptions of the previous embodiments and will not be elaborated here.

The specific implementation for the preset server to obtain the object search results is detailed in the relevant descriptions of the previous embodiments and will not be elaborated here.

In summary, the search apparatus provided in this application sends an object query request to a preset server, triggering the server to: responding to the object query request by obtaining the text information corresponding to the request; retrieving the object index values corresponding to the objects to be retrieved based on the text information, where the object index values include multi-level index values arranged from top to bottom; using an object-to-object association algorithm to determine the first set of retrieval objects similar to the object corresponding to the object index value; determining the second set of retrieval objects based on the object index value and the pre-generated object clustering hierarchy diagram corresponding to the object index value; aggregating the first and second sets of retrieval objects to generate the object search results. This approach enhances the coverage and accuracy of the object search results.

Based on the embodiments described above, the present embodiment further provides an object index prediction model training device, which includes:

First Fine-tuning Module: configured to use the description text of the object as input data and the pre-obtained object index value of the object as output data to construct the first fine-tuning sample.

The first fine-tuning module is also configured to fine-tune the initial object index prediction model based on the first fine-tuning sample, thereby obtaining the fine-tuned object index prediction model.

Second Fine-tuning Module: configured to acquire second fine-tuning samples in real-time according to a preset cycle, and based on the second fine-tuning sample, iteratively fine-tune the fine-tuned object index prediction model to update the object index prediction model. The second fine-tuning sample is constructed by the following method: using the historical query text within a specified time period and the click category sequence corresponding to the historical query text as input data, and using the object index value of the object clicked in response to the historical query text as output data.

Optionally, before fine-tuning the object index prediction model, the device further includes:

Vocabulary Configuration Module: configured to add the various levels of index values from the pre-established object index values as basic input units to the vocabulary of the object index prediction model.

In summary, the object index prediction model training device disclosed in the embodiments of the present application constructs a first fine-tuning sample by using the object's description text as input data and the pre-obtained object index value of the object as output data. The initial object index prediction model is then fine-tuned based on the first fine-tuning sample to obtain a fine-tuned object index prediction model. Subsequently, user query behavior data within a specified time period is continuously obtained according to a preset cycle, and a second fine-tuning sample is constructed. The object index prediction model is then iteratively fine-tuned based on the second fine-tuning sample, which helps improve the accuracy of the object index prediction model in predicting object indices, thereby enhancing the search accuracy of the search method using the object index prediction model.

The embodiments of the present application also provide a non-volatile readable storage medium, which stores one or more modules (programs). When the one or more modules are applied to a device, they cause the device to execute the instructions of the method steps of the embodiments of the present application.

The embodiments of the present application also provide a computer-readable storage medium, which stores computer-executable instructions. When the computer-executable instructions are executed by a processor, they are used to implement the method as described in the embodiments of the present application.

The embodiments of the present application also provide an electronic device, including: a processor, and a memory communicatively connected to the processor; the memory stores computer-executable instructions; the processor executes the computer-executable instructions stored in the memory to implement the method as described in the embodiments of the present application. In this embodiment, the electronic device includes servers, terminal devices, and other such devices.

The embodiments of the present application also disclose a computer program product, comprising a computer program/computer-executable instructions, which, when executed by a processor in an electronic device, implement the method as described in the embodiments of the present application.

The embodiments of the present disclosure can be implemented using any suitable combination of hardware, firmware, software, or any combination thereof to configure the desired device. Such a device may include servers (clusters), terminals, and other electronic devices. FIG. 7 schematically illustrates an exemplary device 700 that may be used to implement the various embodiments described in the present application.

For one embodiment, FIG. 7 illustrates an exemplary device 700, which includes one or more processors 702, a control module (chipset) 704 coupled to at least one of the processors 702, a memory 706 coupled to the control module 704, a non-volatile memory (NVM)/storage device 708 coupled to the control module 704, one or more input/output devices 710 coupled to the control module 704, and a network interface 712 coupled to the control module 704.

The processor 702 may include one or more single-core or multi-core processors, and can be any combination of general-purpose processors or specialized processors (e.g., graphics processors, application processors, baseband processors, etc.). In some embodiments, the device 700 can function as a server, terminal, or other device as described in the embodiments of the present application.

In some embodiments, the device 700 may include one or more computer-readable media (e.g., memory 706 or NVM/storage device 708) with instruction 714, and one or more processors 702 configured to execute instruction 714 to implement modules that perform the actions described in the present disclosure.

In one embodiment, the control module 704 may include any suitable interface controller to provide any appropriate interface to at least one of the processor 702 and/or any suitable device or component in communication with the control module 704.

The control module 704 may include a memory controller module to provide an interface to the memory 706. The memory controller module may be a hardware module, a software module, and/or a firmware module.

The memory 706 may be used, for example, to load and store data and/or instructions 714 for the device 700. In one embodiment, the memory 706 may include any suitable volatile memory, such as appropriate DRAM. In some embodiments, the memory 706 may include Double Data Rate Type 4 Synchronous Dynamic Random-Access Memory (DDR4 SDRAM).

In one embodiment, the control module 704 may include one or more input/output controllers to provide interfaces to the NVM/storage device 708 and the one or more input/output devices 710.

For example, the NVM/storage device 708 may be used to store data and/or instructions 714. The NVM/storage device 708 may include any suitable non-volatile memory (e.g., flash memory) and/or may include any appropriate one or more non-volatile storage devices (e.g., one or more hard disk drives (HDDs), one or more compact disk (CD) drives, and/or one or more digital versatile disk (DVD) drives).

The NVM/storage device 708 may include storage resources that are installed as part of the device 700, or it may be accessible by the device without necessarily being part of the device. For example, the NVM/storage device 708 may be accessed via one or more input/output devices 710 over a network.

One or more input/output devices 710 may provide interfaces for the device 700 to communicate with any other suitable devices. The input/output devices 710 may include communication components, audio components, sensor components, etc. The network interface 712 may provide an interface for the device 700 to communicate via one or more networks. The device 700 can wirelessly communicate with one or more components of a wireless network according to any standard and/or protocol from one or more wireless network standards and/or protocols, such as accessing wireless networks based on communication standards like Bluetooth, WiFi, 2G, 3G, 4G, 5G, or combinations thereof.

For one embodiment, at least one of the processors 702 may be logically packaged together with one or more controllers (e.g., memory controller module) of the control module 704. For one embodiment, at least one of the processors 702 may be logically packaged together with one or more controllers of the control module 704 to form a System-in-Package (SiP). For one embodiment, at least one of the processors 702 may have the logic of one or more controllers of the control module 704 integrated on the same die. For one embodiment, at least one of the processors 702 may have the logic of one or more controllers of the control module 704 integrated on the same die to form a System-on-Chip (SoC).

In various embodiments, the device 700 may include, but is not limited to, a server, desktop computing device, or mobile computing device (e.g., laptop, handheld computing device, tablet, netbook, etc.), and other terminal devices. In various embodiments, the device 700 may have more or fewer components and/or a different architecture. For example, in some embodiments, the device 700 may include one or more cameras, a keyboard, a liquid crystal display (LCD) screen (including a touchscreen display), non-volatile memory ports, multiple antennas, a graphics chip, an application-specific integrated circuit (ASIC), and speakers.

In this case, the detection device may use a master control chip as the processor or control module, with sensor data, location information, and other data stored in the memory or NVM/storage device. The sensor group can serve as input/output devices, and the communication interface may include a network interface.

The embodiments of the present application also provide an electronic device, comprising: a processor; and a memory storing executable code, wherein, when the executable code is executed, the processor performs one or more methods as described in the embodiments of the present application. The memory in the embodiments of the present application can store various types of data, such as target files, file-application association data, and other data, including user behavior data, thereby providing a data foundation for various processing tasks.

The embodiments of the present application also provide one or more machine-readable media storing executable code, which, when executed, cause a processor to perform one or more methods as described in the embodiments of the present application.

For the device embodiments, since they are essentially similar to the method embodiments, the description is relatively simple. Relevant details can be referred to in the description of the method embodiments.

The various embodiments in this specification are described in a progressive manner, with each embodiment focusing on the differences from other embodiments. The similar or identical parts between the embodiments can be referred to across the embodiments.

The embodiments of this application are described with reference to the flowcharts and/or block diagrams of the methods, terminal devices (systems), and computer program products according to the embodiments of the present application. It should be understood that each process and/or block in the flowchart and/or block diagram, as well as combinations of processes and/or blocks in the flowchart and/or block diagram, can be implemented by computer program instructions. These computer program instructions may be provided to a general-purpose computer, a special-purpose computer, an embedded processor, or other programmable data processing terminal devices to produce a machine, such that the instructions executed by the processor of the computer or other programmable data processing terminal device implement the functions specified in one or more processes or blocks of the flowchart or block diagram.

These computer program instructions may also be stored in a computer-readable storage medium that can direct a computer or other programmable data processing terminal device to work in a specific manner, such that the instructions stored in the computer-readable storage medium produce a manufactured article, including an instruction apparatus, that implements the functions specified in one or more processes or blocks of the flowchart or block diagram.

These computer program instructions may also be loaded onto a computer or other programmable data processing terminal device, such that a series of operational steps are performed on the computer or other programmable terminal device to produce a computer-implemented process, thereby enabling the instructions executed on the computer or other programmable terminal device to provide the steps for implementing the functions specified in one or more processes or blocks of the flowchart or block diagram.

Although the preferred embodiments of the present application have been described, those skilled in the art, upon understanding the basic inventive concepts, may make various changes and modifications to these embodiments. Therefore, the appended claims are intended to be interpreted to include not only the preferred embodiments but also all changes and modifications that fall within the scope of the embodiments of the present application.

Finally, it should be noted that relational terms such as “first” and “second” are used herein merely to distinguish one entity or operation from another, and do not necessarily imply any actual relationship or order between the entities or operations. Furthermore, the terms “include,” “comprise,” or any variations thereof are intended to cover non-exclusive inclusion, meaning that a process, method, item, or terminal device that includes a series of elements not only includes those elements but also other elements not expressly listed, or includes elements inherent to the process, method, item, or terminal device. In the absence of further limitations, an element defined by the phrase “including a . . . ” does not exclude the presence of additional identical elements in the process, method, item, or terminal device that includes the element.

The above provides a detailed description of the object index construction method, object index prediction model training method, search method, e-commerce platform, electronic device, storage medium, and computer program product provided by the present application. Specific examples have been used to illustrate the principles and implementation of the present application. The descriptions of the above embodiments are intended to aid in understanding the methods and core ideas of the present application. At the same time, for those skilled in the art, modifications may be made to the specific implementations and scope of application based on the ideas of the present application. Therefore, the contents of this specification should not be construed as limiting the present application.

What is claimed is:

1. A method for establishing an object index, comprising:
obtaining multimodal features of each object under a target leaf category;
performing multi-level clustering on the objects under the target leaf category based on the multimodal features to obtain an object clustering hierarchy diagram;
establishing an object index value for each of the objects based on the object clustering hierarchy diagram.

2. The method of claim 1, wherein, after establishing the object index value for each of the objects based on the object clustering hierarchy diagram, the method further comprises:
obtaining the multimodal features of an incremental object under the leaf category;
selecting a target clustering category from the object clustering hierarchy diagram that matches the incremental object based on the multimodal features;
adding the incremental object to the target clustering category to update the object clustering hierarchy diagram;
obtaining the object index value for the incremental object based on the updated object clustering hierarchy diagram.

3. The method of claim 2, wherein selecting a target clustering category from the object clustering hierarchy diagram that matches the incremental object based on the multimodal features comprises:
obtaining category feature vectors for each bottom-level clustering category in the object clustering hierarchy diagram;
selecting a candidate clustering category from the bottom-level clustering categories based on a similarity distance between the multimodal features of the incremental object and the category feature vectors;
determining the candidate clustering category as the target clustering category for the incremental object based on a number of existing objects in the candidate clustering category and/or the number of objects in a sibling clustering category of the candidate clustering category, or selecting the target clustering category from the sibling clustering categories, wherein the sibling clustering category is a clustering category under a parent category of the candidate clustering category.

4. The method of claim 1, wherein the multimodal features of the object are obtained by:
obtaining one or more feature vectors of the object, the feature vectors including a text feature vector, an image feature vector, and an efficiency feature vector;
concatenating the obtained feature vectors of the object to form the corresponding multimodal features of the object.

5. The method of claim 1, wherein the object clustering hierarchy diagram is used to describe the hierarchical clustering categories to which the object belongs during the multi-level clustering process, and establishing the object index value based on the object clustering hierarchy diagram comprises:
determining a top-level index value for the object based on the target leaf category;
determining hierarchical index values corresponding to each hierarchical clustering category to which the object belongs;
concatenating the top-level index value and the hierarchical index values in descending order of the hierarchical clustering categories to generate the object index value.

6. A non-transitory computer-readable storage medium configured with instructions executable by one or more processors to cause the one or more processors to perform the method of claim 1.

7. An electronic device comprising:
one or more processors; and
one or more computer-readable memories coupled to the one or more processors and having instructions stored thereon that are executable by the one or more processors to perform the method of claim 1.

8. A search method comprising:
in response to an object query request, obtaining text information corresponding to the object query request;
based on the text information, obtaining an object index value, wherein the object index value comprises multi-level index values from top to bottom;
using an object-to-object association algorithm to determine a first candidate object to be retrieved that is similar to the object corresponding to the object index value;
determining a second candidate object to be retrieved based on the object index value and a pre-generated object clustering hierarchy diagram corresponding to the object index value;
aggregating the first candidate object to be retrieved and the second candidate object to be retrieved to obtain an object search result.

9. The method of claim 8, wherein determining the second candidate object to be retrieved based on the object index value and the pre-generated object clustering hierarchy diagram corresponding to the object index value comprises:
parsing the object index value to obtain top-level index value and sub-top-level index value;
determining the second candidate object to be retrieved corresponding to the sub-top-level index value based on the pre-generated object clustering hierarchy diagram corresponding to the top-level index value.

10. The method according to claim 9, wherein the object clustering hierarchy diagram is used to describe the hierarchical clustering categories to which the objects belong during multi-level clustering process of the objects under a target leaf category, wherein the target leaf category corresponds to the top-level index value; and wherein, based on the pre-generated object clustering hierarchy diagram corresponding to the top-level index value, determining the second candidate object to be retrieved corresponding to the sub-top-level index value comprises:
obtaining the object corresponding to the sub-top-level index value as a candidate object to be retrieved based on the pre-generated object clustering hierarchy diagram corresponding to the top-level index value;
selecting a preset number of candidate objects to be retrieved from the candidate objects in descending order of their preset metric values, as the second candidate object to be retrieved.

11. The method according to claim 8, wherein obtaining the text information corresponding to the object query request comprises:
obtaining the query text corresponding to the object query request;
obtaining a click category sequence corresponding to the query text;
obtaining the text information corresponding to the object query request based on the query text and the click category sequence.

12. The method according to claim 8, wherein obtaining the object index value based on the text information comprises:
inputting the text information into a pre-trained object index prediction model to obtain the object index value output by the object index prediction model.

13. The method according to claim 8, wherein obtaining the object index value based on the text information comprises:
matching the text information with historical text information corresponding to historical object query requests to obtain a match result;
in response to the match result indicating successful matching with the historical text information, obtaining pre-stored object index value predicted based on the historical text information as the object index value corresponding to the object to be retrieved;
in response to the match result indicating no match with target text information corresponding to the historical object query request, inputting the text information into a pre-trained object index prediction model to obtain the object index value output by the object index prediction model.

14. A search method comprising:
obtaining a query text entered by a user based on an object query operation;
generating an object query request based on the query text;
sending the object query request to a preset server;
displaying an object search result sent by the preset server in response to the object query request, wherein the object search result is obtained by the preset server through a method according to claim 8.

15. A non-transitory computer-readable storage medium configured with instructions executable by one or more processors to cause the one or more processors to perform the method of claim 8.

16. An electronic device comprising:
one or more processors; and
one or more computer-readable memories coupled to the one or more processors and having instructions stored thereon that are executable by the one or more processors to perform the method of claim 8.

17. A method for training an object index prediction model comprising:
using description text of an object as input data and pre-obtained object index value of the object as output data to construct a first fine-tuning sample;
fine-tuning an initial object index prediction model based on the first fine-tuning sample to obtain a fine-tuned object index prediction model;
periodically obtaining a second fine-tuning sample in real time and iteratively fine-tuning the fine-tuned object index prediction model based on the second fine-tuning sample to update the object index prediction model, wherein the second fine-tuning sample is constructed by:
using historical query text within a specified time period and click category sequences corresponding to the historical query text as input data;
using the object index value of the object clicked in response to the historical query text as output data.

18. The method of claim 17, wherein, prior to fine-tuning the object index prediction model, the method further comprises:
adding each level of pre-established object index values as a basic input unit to vocabulary of the object index prediction model.

19. A non-transitory computer-readable storage medium configured with instructions executable by one or more processors to cause the one or more processors to perform the method of claim 17.

20. An electronic device comprising:
one or more processors; and
one or more computer-readable memories coupled to the one or more processors and having instructions stored thereon that are executable by the one or more processors to perform the method of claim 17.
